(19) United States
(12) Patent Application Publication
(10) Pub. No.: US 2010/0078374 A1
(43) Pub. Date: Apr. 1, 2010

(54) ALIGNMENT APPARATUS FOR EXTERNAL PRESSURE TYPE MODULE AND FILTERING SYSTEM COMPRISING THE SAME

(75) Inventors: Kwang-Jin Lee, Yongin-si (KR); Ah Reum Lee, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: KOLON INDUSTRIES, INC., Kwacheon-si (KR)

(21) Appl. No.: 12/568,164

(22) Filed: Sep. 28, 2009

(30) Foreign Application Priority Data
Sep. 29, 2008 (KR) 10-2008-0095112

(51) Int. Cl. B01D 35/30; B25B 27/14

(52) U.S. Cl. 210/232; 29/281.5

(57) ABSTRACT

An alignment apparatus for external pressure type module and a filtering system comprising the same is disclosed, which is capable of supporting the external pressure type module while being connected to a pipe and the filtering system, wherein the alignment apparatus comprises a supporting member having a central through-hole into which the external pressure type module is to be inserted; and the filtering system comprises an external pressure type module, a pipe connected with the external pressure type module, and an alignment apparatus for supporting the external pressure type module while being connected with the pipe.

This application claims the benefit of Korean Patent Application No. 10-2008-0095112 filed on Sep. 29, 2008, which is hereby incorporated by reference for all purposes as if fully set forth herein.

### BACKGROUND OF THE INVENTION

1. Field of the Invention

The present invention relates to an apparatus for aligning an external pressure type module and a filtering system comprising the same, and more particularly to an alignment apparatus for supporting an external pressure type module while being connected to a pipe and a filtering system comprising the same.

2. Discussion of the Related Art

A separation method using a membrane has lots of advantages over the method based on heating or phase-changing. Among the advantages is high reliability of water treatment since the water purity required can be easily and stably satisfied by adjusting the size of the pores of a membrane. Furthermore, since the separation method using a membrane does not require a heating process, a membrane can be used with microorganism which is useful for separation process but may be adversely affected by heat.

Among the membrane employing separation methods is a method using a hollow fiber membrane module which comprises a bundle of hollow fiber membranes. Conventionally, the hollow fiber membrane module has been widely used in a micro-filtration field for producing axenic water, drinking water, super pure water, and so on. Recently, however, the application of the hollow fiber membrane module is being expanded to include sewage and waste water treatment, solid-liquid separation in a septic tank, removal of suspended solid (SS) from industrial wastewater, filtration of river, filtration of industrial water, and filtration of swimming pool water.

One kind of the hollow fiber membrane modules is a suction type hollow fiber membrane module (or may also be referred to as an internal pressure type hollow fiber membrane module) which is submerged into a water tank filled with fluid to be treated. Negative pressure is applied to the inside of the hollow fiber membranes, whereby only fluid passes through the wall of each membrane and solid elements such as impurities and sludge are rejected. This suction type hollow fiber membrane module is advantageous in that the manufacturing cost is relatively low and that the installation and maintenance cost is reduced since a facility for circulating fluid is not required. However, the suction type hollow fiber membrane module has a disadvantage of the limitation on flux per unit period.

In opposition to the suction type hollow fiber membrane module, there is an external pressure type hollow fiber membrane module. In case of the external pressure type hollow fiber membrane module, external pressure is applied to fluid to be treated so that only fluid passes through the wall of each membrane and solid elements such as impurities and sludge are rejected. Even though the external pressure type hollow fiber membrane module necessarily requires a facility for circulating fluid, a flux per unit period in the external pressure type hollow fiber membrane module is relatively larger than a flux per unit period in the suction type hollow fiber membrane module.

FIG. 1 illustrates an exemplary external pressure type module.

As shown in FIG. 1, the external pressure type module 10 includes a plurality of hollow fiber membranes 11, wherein each hollow fiber membrane 11 has such a hollow as to enable the permeation of fluid from an external surface of each membrane 11 to an internal surface of each membrane 11. The plurality of hollow fiber membranes 11 are grouped into bundles, wherein longitudinal directions of the respective hollow fiber membranes 11 are provided in parallel.

At least one end of each of the hollow fiber membrane modules 11 is potted into a first potting portion 12. Then, a predetermined portion of the first potting portion 12 is cut so as to open the hollow at the one end of each hollow fiber membrane 11.

The first potting portion 12 may be made of thermosetting resin, for example, epoxy resin, urethane resin, or silicon rubber. Selectively, the thermosetting resin may be mixed with filler such as silica, carbon black, or carbon fluoride so as to enhance strength of the first potting portion 12 and simultaneously reduce setting shrinkage of the first potting portion 12.

The other end of each hollow fiber membrane 11 is potted into a second potting portion 13. A material used for the second potting portion 13 may be the same as or different from a material used for the first potting portion 12. Selectively, instead of potting the other end of each hollow fiber membrane 11, the other end of each hollow fiber membrane 11 may be sealed by thermosetting resin.

A plurality of openings 13a are provided in the second potting portion 13 so that air for aeration cleaning is uniformly supplied to the hollow fiber membranes 11.

The first potting portion 12 having the plurality of hollow fiber membranes 11 potted thereinto is fixedly adhered to an inner surface of a module case 14 by a sealant, whereby it is possible to prevent permeated water sequentially flowing into the hollow through the hollow fiber membrane 11 and being discharged through the open end of the hollow fiber membrane 11 from being mixed with feed water to be treated.

The feed water to be treated is introduced into the module case 14 through a feed-water inlet port 15. Then, the feed water introduced into the module case 14 is pressurized by a pump, whereby some of the feed water permeates through the hollow fiber membrane 11 and then flows into the hollow of the hollow fiber membrane 11. Thus, permeated water permeating through the hollow fiber membrane 11 is discharged to the external through a permeated-water outlet port 16 of the module case 14. Also, the feed water (hereinafter, referred to as “concentrated water”) whose concentration of solid elements such as impurities and sludge becomes higher due to the discharge of permeated water is discharged to the external through a concentrated-water outlet port 17.

During the filtering process, air for cleaning the hollow fiber membrane 11 is supplied to the inside of the module case 14 through an air inlet port 18.

Selectively, both the feed water to be treated and the air for cleaning the hollow fiber membrane 11 may be supplied to the inside of the module case 14 through one inlet port 18. In this case, both the feed water to be treated and the air for cleaning the hollow fiber membrane 11 flow to the hollow fiber membrane 11 through the plurality of openings 13a provided in the second potting portion 13.

FIG. 2 illustrates an exemplary filtering system comprising the external pressure type module 10.

The feed water to be treated is transferred to a circulation tank 20, and is then transferred to the external pressure type module 10 through a pipe by a feed-water supplying pump 30. Thereafter, the permeated water permeating through the hollow fiber membrane 11 is transferred to a permeated-water tank 50, and the concentrated water is again transferred to the circulation tank 20.

In order to carry out a backwashing process for the hollow fiber membrane 11 after stopping the filtering process, the permeated water stored in the permeated-water tank 50 is transferred to the external pressure type module 10 by a backwashing pump 60. Also, compressed air is injected into the inside of the external pressure type module 10 by the air inlet port 18 through the use of air supplying means 40, to thereby clean the hollow fiber membrane 11 by aeration.

When connecting the external pressure type module 10 with the filtering system, it is important to precisely connect the feed-water inlet port 15, the air inlet port 18, the permeated-water outlet port 16, and the concentrated-water output port 17 of the external pressure type module 10 with the corresponding pipes of the filtering system.

However, the weight and size of the external pressure type module 10 is rapidly increasing based on the recent trend toward large-scale modules, that is, the weight of external pressure type module 10 is approximately 40 to 80 kilograms. This heavy weight of the external pressure type module 10 may cause difficulties in carrying out the connection process between the external pressure type module 10 and the filtering system since the heavy external pressure type module 10 has to be firstly conveyed to the filtering system by physical forces of several people, and the inlet and output ports 15, 16, 17 and 17 of the external pressure type module 10 have to be precisely positioned and maintained in the corresponding pipes of the filtering system by physical forces of several people until completing the connecting process therebetween.

### SUMMARY OF THE INVENTION

Accordingly, the present invention is directed to an alignment apparatus for supporting an external pressure type module while the external pressure type module being connected to a pipe and a filtering system comprising the same that substantially obviates one or more of the problems due to limitations and disadvantages of the related art.

An aspect of the present invention is to provide an alignment apparatus for external pressure type module, which is capable of supporting a large-sized external pressure type module while the module is connected with a pipe of a filtering system, and the filtering system comprising the same.

Another aspect of the present invention is to provide an alignment apparatus for external pressure type module, which is capable of precisely adjusting a position of external pressure type module supported by the alignment apparatus, and a filtering system comprising the same.

Another aspect of the present invention is to provide an alignment apparatus for external pressure type module, which is capable of easily transferring a large-sized external pressure type module to a filtering system to be connected.

A further aspect of the present invention is to provide an alignment apparatus for external pressure type module, on which a large-sized external pressure type module is loaded with easiness.

Additional features and aspects of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, there is provided an alignment apparatus for supporting an external pressure type module while the external pressure type module being connected with a pipe, the alignment apparatus comprising a supporting member having a central through-hole into which the external pressure type module is to be inserted.

In another aspect of the present invention, there is provided a filtering system comprising an external pressure type module; a pipe connected with the external pressure type module; and an alignment apparatus for supporting the external pressure type module while the external pressure type module being connected with the pipe.

It is to be understood that both the foregoing general description and the following detailed description are exemplary and explanatory and are intended to provide further explanation of the invention as claimed.

### BRIEF DESCRIPTION OF THE DRAWING

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates an exemplary external pressure type module;

FIG. 2 illustrates an exemplary filtering system comprising an external pressure type module;

FIG. 3 illustrates a connection between an external pressure type module and a pipe of a filtering system;

FIG. 4 illustrates an external pressure type module and an alignment apparatus according to the first embodiment of the present invention;

FIG. 5 illustrates a supporting member according to one embodiment of the present invention;

FIG. 6 illustrates an alignment apparatus for external pressure type module according to the second embodiment of the present invention;

FIG. 7 illustrates an alignment apparatus for external pressure type module according to the third embodiment of the present invention; and

FIG. 8 and FIG. 9 illustrate an alignment apparatus for external pressure type module according to the fourth embodiment of the present invention.

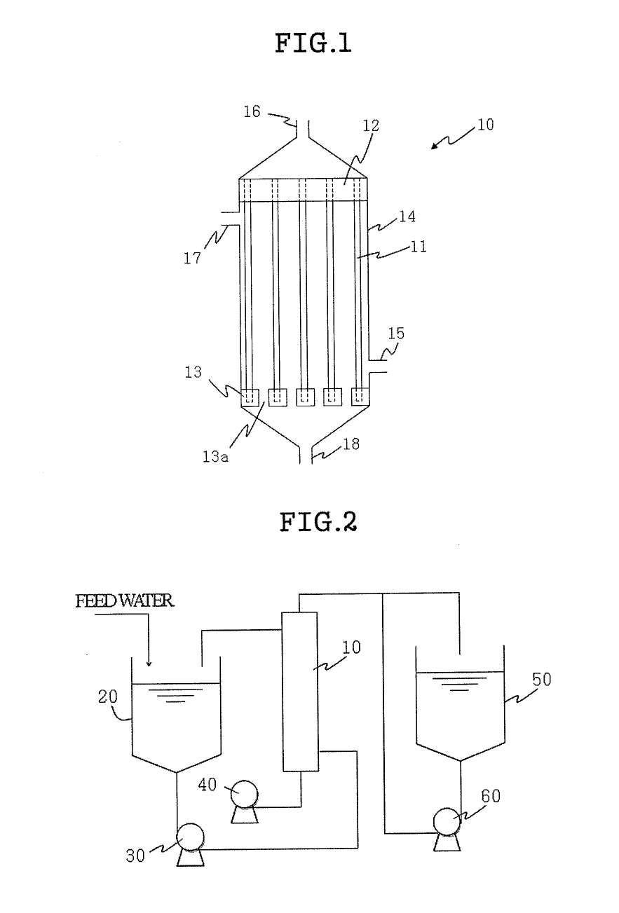

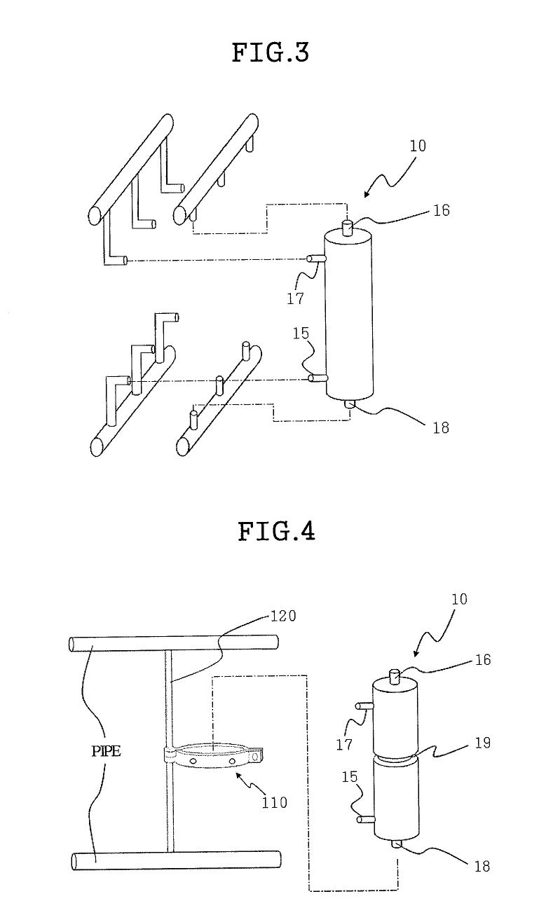

### DETAILED DESCRIPTION OF THE ILLUSTRATED EMBODIMENTS

Reference will now be made in detail to an embodiment of the present invention, example of which is illustrated in the accompanying drawings.

Hereinafter, an alignment apparatus for external pressure type module according to the present invention and a filtering system comprising the same will be described with the accompanying drawings.

The present invention can be identically applied to both a through-both-ends water collection type and a through-one-end water collection type, wherein the through-both-ends water collection type uses two headers so as to collect permeates from both ends of a hollow fiber membrane, and the through-one-end water collection type use one header so as to collect permeates from one end of a hollow fiber membrane.

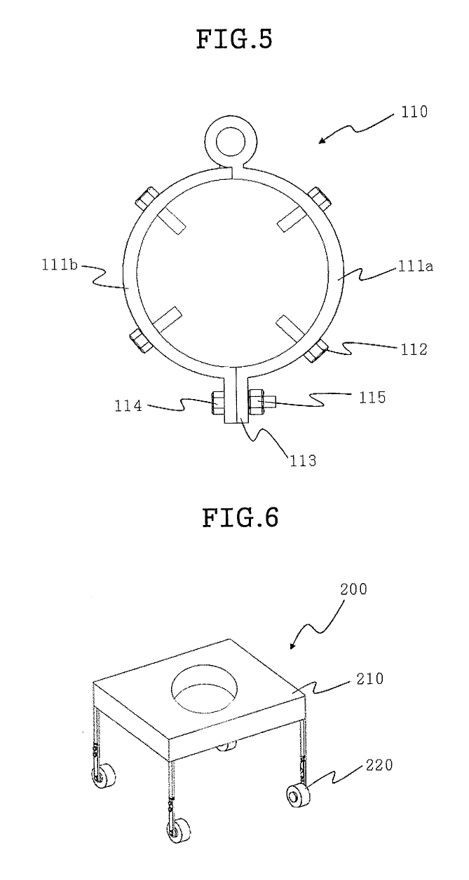

FIG. 4 illustrates an external pressure type module and an alignment apparatus according to the first embodiment of the present invention, and FIG. 5 illustrates a supporting member 110 according to one embodiment of the present invention.

According to the first embodiment of the present invention, a vertical body 120 is connected with pipes to be connected with an external pressure type module 10. The vertical body 120 is connected with the supporting member 110 having a central through-hole into which the external pressure type module 10 is to be inserted.

The vertical body 120 may be provided to be fixedly connected with the pipes so that the vertical body 120 remains in the filtering system even after completing the process of connecting the external pressure type module 10 with the filtering system; or the vertical body 120 may be provided to be detachably connected with the pipes so that the vertical body 120 exists only during the process of connecting the external pressure type module 10 with the filtering system.

The supporting member 110 includes first and second receivers 111a and 111b which are pivotally connected with the vertical body 120. According as the first and second receivers 111a and 111b are pivotally moved to be farther apart from each other, the through-hole formed in the center of the supporting member 110 becomes open. Reversely, according as the first and second receivers 111a and 111b are pivotally moved to be closer to each other, flanges 113 formed in the end portions of the respective first and second receivers 111a and 111b are in contact to each other, whereby the through-hole formed in the center of the supporting member 110 becomes closed. When the through-hole is closed, the first and second receivers 111a and 111b are engaged to each other through the use of engagement bolt 114 passing through the flanges 113. In addition, the engagement bolt 114 may be fastened with an engagement nut 115 so as to enhance the engagement of the first and second receivers 111a and 111b.

The supporting member 110 includes a plurality of fixing members 112 for fixedly providing the external pressure type module 10 in the through-hole, wherein the fixing members 112 may be bolts. The respective bolts passing through the first or second receiver 111a or 111b can maintain the external pressure type module 10 to be fixedly provided in the through-hole.

Selectively, the plurality of fixing members 112 may be protrusions formed in the inner side of the first or second receiver 111a or 111b. In this case, a groove 19 is formed along the circumferential surface of the external pressure type module 10. When the through-hole formed in the center of the supporting member 110 is opened by pivotally moving the first and second receivers 111a and 111b to be farther apart from each other, the external pressure type module 10 is inserted into the through-hole. Thereafter, the first and second receivers 111a and 111b are pivotally moved to be closer to each other, the plurality of protrusions formed in the inner side of the first and second receivers 111a and 111b are inserted into the groove 19 formed along the circumferential surface of the external pressure type module 10. Accordingly, the external pressure type module 10 is fixedly provided in the through-hole by the plurality of protrusions.

In order to precisely adjust a position of the external pressure type module 10 when connecting the external pressure type module 10 with the filtering system, a lift mechanism (to be explained) can be introduced in the first embodiment of the present invention. Thus, the alignment apparatus may be provided in such a way that the supporting member 110 is moved along the longitudinal direction of the vertical body 120.

FIG. 6 illustrates an alignment apparatus for external pressure type module according to the second embodiment of the present invention.

As shown in FIG. 6, the alignment apparatus 200 according to the second embodiment of the present invention includes a supporting member 210 having a through-hole in the center thereof, wherein the external pressure type module 10 is inserted into the through-hole formed in the center of the supporting member 210. The supporting member 210 may include fixing members, for example, a plurality of bolts (not shown), for fixedly providing the external pressure type module 10 in the through-hole. Also, a rotary member 220 is provided at a lower side of the supporting member 210 so as to enable a smooth movement of the supporting member 210.

According to the second embodiment of the present invention, the external pressure type module 10 loaded on the alignment apparatus 200 can be easily transported to the pipe of the filtering system. In addition, when trying to connect the external pressure type module 10 to the pipe of the filtering system, the external pressure type module 10 is stably supported by the supporting member 210. As a result, the connection process between the external pressure type module 10 and the pipe of the filtering system can be carried out with easiness.

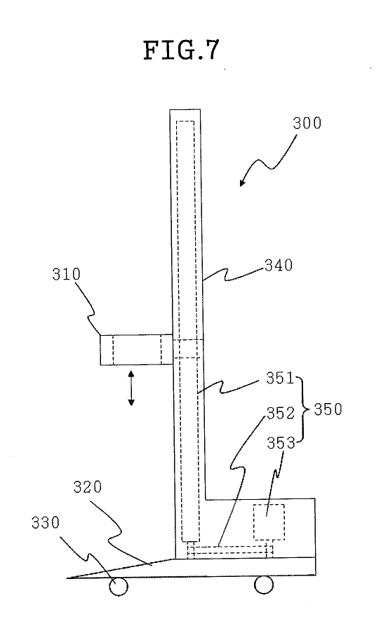

FIG. 7 illustrates an alignment apparatus for external pressure type module according to the third embodiment of the present invention.

As shown in FIG. 7, the alignment apparatus 300 according to the third embodiment of the present invention includes a horizontal body 320; a vertical body 340 which is perpendicularly connected with the horizontal body 320; and a supporting member 310 which is connected with the vertical body 340 in such a way that the supporting member 310 is moved along the longitudinal direction of the vertical body 340. There is a through-hole in the center of the supporting member 310 so that the external pressure type mole 10 is inserted into the through-hole. Thus, the external pressure type module 10 inserted into the through-hole may be fixedly provided in the supporting member 310 through the use of fixing member (not shown).

The alignment apparatus 300 according to the third embodiment of the present invention includes a lift mechanism 350 which is capable of moving the supporting member 310 along the longitudinal direction of the vertical body 340. The lift mechanism 350 may include a motor 353; a ball screw 351 which extends in the longitudinal direction of the vertical body 340; and a belt 352 for transmitting a rotary power of the motor 353 to the ball screw 351.

At this time, the vertical body 340 in itself may be the ball screw 351. The vertical body 340 may include an outer tube in addition to the ball screw 351, wherein the outer tube covers the external of the vertical body 340. A predetermined portion of the supporting member 310 gears with the ball screw 351 so as to make the supporting member 310 move linearly in parallel to the rotating axis of the ball screw 351 according to the rotation of the ball screw 351. According to the third embodiment of the present invention, the motor 353 is driven by simply operating a switch (not shown), to thereby precisely adjust the position of the external pressure type module 10 loaded on the alignment apparatus 300. As a result, the external pressure type module 10 can be connected with the pipe of the filtering system with easiness.

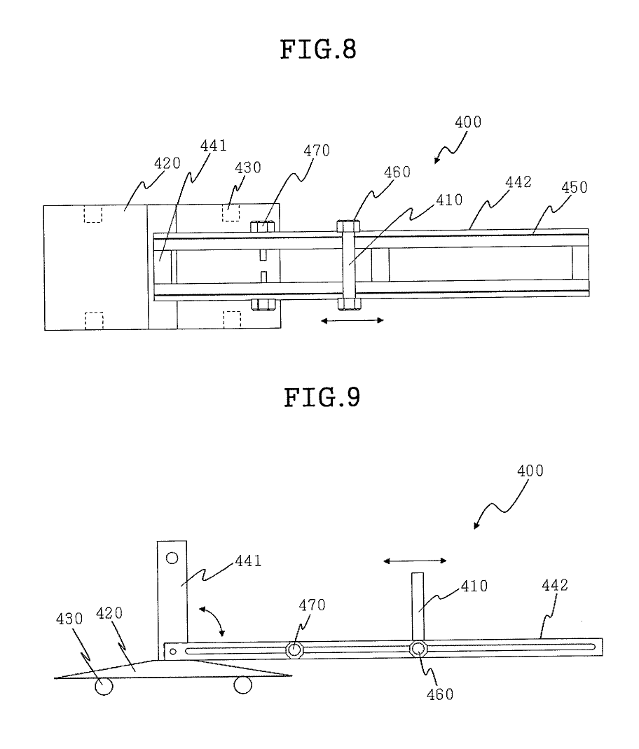

Selectively, as shown in FIG. 8 and FIG. 9, the lift mechanism 350 may be comprised of a moving rail 450 and a fixing member 460, wherein the moving rail 450 is extending in the longitudinal direction of the vertical body 340 so as to guide the movement of the supporting member 310, and the fixing member 460 is provided for fixing the supporting member 310 to a predetermined portion of the vertical body 340.

Also, the alignment apparatus 300 according to the third embodiment of the present invention may include a rotary member 330 which is provided at a lower side of the horizontal body 320 so as to enable a smooth movement of the horizontal body 320, whereby the external pressure type module 10 loaded on the alignment apparatus 300 can be easily transported to the pipe of the filtering system.

FIG. 8 and FIG. 9 illustrate an alignment apparatus for external pressure type module according to the fourth embodiment of the present invention.

The alignment apparatus 400 according to the fourth embodiment of the present invention includes a horizontal body 420; a first vertical body 441 which is perpendicularly connected with the horizontal body 420; a second vertical body 442 which is pivotally connected with the first vertical body 441; and a supporting member 410 which is connected with the second vertical body 442 in such a way that the supporting member 410 is moved along the longitudinal direction of the second vertical body 442.

There is a through-hole in the center of the supporting member 410 so that the external pressure type mole 10 is inserted into the through-hole. Thus, the external pressure type module 10 inserted into the through-hole may be fixedly provided in the supporting member 410 through the use of fixing member (not shown).

According to the fourth embodiment of the present invention, the second vertical body 442 is pivotally connected with the first vertical body 441. Thus, when inserting the external pressure type module 10 into the through-hole of the supporting member 410 so as to load the external pressure type module 10 on the alignment apparatus 400, the second vertical body 442 can be horizontally laid down on the ground. Accordingly, it is advantageous in that the external pressure type module 10 is loaded on the alignment apparatus 400 while maintaining the laid-down external pressure type module 10.

After inserting one end of the external pressure type module 10 into the through-hole of the supporting member 410, the second vertical body 442 is pivotally moved to the opposite direction so that the second vertical body 442 is aligned in parallel to the first vertical body 441. Then, the second vertical body 442 is fixed to the first vertical body 441 through the use of second fixing member 470 so that pivotal movement of the second vertical body 442 on the first vertical body 441 is prevented.

Then, the alignment apparatus 400 with the external pressure type module 10 loaded thereon is transported to the pipe of the filtering system to be connected with the external pressure type module 10. According to the fourth embodiment of the present invention, there is a rotary member 430 which is provided at a lower side of the horizontal body 420 so as to enable a smooth movement of the alignment apparatus 400 with the external pressure type module 10 loaded thereon.

According to the fourth embodiment of the present invention, there is a moving rail 450 for guiding the movement of the supporting member 410, wherein the moving rail 450 is extending in the longitudinal direction of the second vertical body 442. Thus, after transporting the external pressure type module 10 to the pipe of the filtering system, the position of the external pressure type module 10 can be precisely adjusted by moving the supporting member 410 along the moving rail 450. When the position of the external pressure type module 10 is adjusted for connection with the pipe of the filtering system, the supporting member 410 is fixed to a predetermined portion of the second vertical body 442 through the use of first fixing member 460. As a result, the fourth embodiment of the present invention enables to precisely adjust the position of the external pressure type module 10 loaded on the alignment apparatus 40, and further to connect the external pressure type module 10 with the pipe of the filtering system with easiness.

As mentioned above, the alignment apparatus for external pressure type module according to the present invention and the filtering system comprising the same have the following advantages.

When carrying out the process of connecting the large-sized external pressure type module with the pipe of the filtering system through the use of alignment apparatus according to the present invention, the large-sized external pressure type module is stably supported at the precisely desirable position until completion of the connection process between the large-sized external pressure type module and the pipe of the filtering system. Since the position of the external pressure type module can be easily adjusted under such circumstance that the external pressure type module is supported stably, the connection process between the external pressure type module and the filtering system can be efficiently carried out with the minimized labor requirement.

Also, the large-sized external pressure type module can be easily loaded on the alignment apparatus according to the present invention, and the alignment apparatus with the large-sized external pressure type module loaded thereon can be easily transported to the filtering system, thereby maximizing efficiency.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An alignment apparatus for supporting an external pressure type module while the external pressure type module being connected with a pipe, the alignment apparatus comprising a supporting member having a central through-hole into which the external pressure type module is to be inserted.

2. The alignment apparatus of claim 1, further comprising a vertical body connected with the pipe, wherein the supporting member is connected with the vertical body.

3. The alignment apparatus of claim 2,
wherein the supporting member comprises first and second receivers pivotally connected with the vertical body, and a fixing member for fixedly providing the external pressure type module in the through-hole, and
wherein the first and second receivers have flanges and are engaged to each other with an engagement bolt passing through the flanges.

4. The alignment apparatus of claim 1, further comprising a rotary member for enabling the movement of the supporting member, the rotary member positioned at a lower side of the supporting member.

5. The alignment apparatus of claim 1, further comprising:
a horizontal body; and
a vertical body perpendicularly connected with the horizontal body,
wherein the supporting member is connected with the vertical body in such a way that the supporting member is capable of being moved along the longitudinal direction of the vertical body.

6. The alignment apparatus of claim 5, further comprising a lift mechanism for moving the supporting member along the longitudinal direction of the vertical body.

7. The alignment apparatus of claim 6, wherein the lift mechanism comprises:
a motor;
a ball screw extending in the longitudinal direction of the vertical body; and
a belt for transmitting a rotary power of the motor to the ball screw.

8. The alignment apparatus of claim 6, wherein the lift mechanism comprises:
a moving rail for guiding the movement of the supporting member, the moving rail extending in the longitudinal direction of the vertical body; and
a fixing member for fixing the supporting member to a predetermined portion of the vertical body.

9. The alignment apparatus of claim 5, further comprising a rotary member for enabling the movement of the horizontal body, the rotary member provided at a lower side of the horizontal body.

10. The alignment apparatus of claim 1, further comprising:
a horizontal body;
a first vertical body perpendicularly connected with the horizontal body; and
a second vertical body pivotally connected with the first vertical body,
wherein the supporting member is connected with the second vertical body in such a way that the supporting member is capable of being moved along the longitudinal direction of the second vertical body.

11. The alignment apparatus of claim 10, further comprising a fixing member for fixing the second vertical body to the first vertical body so that pivotal movement of the second vertical body on the first vertical body is prevented.

12. The alignment apparatus of claim 10, further comprising a rotary member for enabling the movement of the horizontal body, the rotary member provided at a lower side of the horizontal body.

13. A filtering system comprising:
an external pressure type module;
a pipe connected with the external pressure type module; and
an alignment apparatus for supporting the external pressure type module while the external pressure type module being connected with the pipe.

14. The filtering system of claim 13, wherein the alignment apparatus comprises:
a vertical body; and
a supporting member having a central through-hole into which the external pressure type module is to be inserted, the supporting member connected with the vertical body.

15. The filtering system of claim 14, wherein the alignment apparatus further comprises a lift mechanism to move the supporting member along the longitudinal direction of the vertical body.

16. The filtering system of claim 15, wherein the lift mechanism comprises:
a motor;
a ball screw extending in the longitudinal direction of the vertical body; and
a belt for transmitting a rotary power of the motor to the ball screw.

17. The filtering system of claim 15, wherein the lift mechanism comprises:
a moving rail for guiding the movement of the supporting member, the moving rail extending in the longitudinal direction of the vertical body; and
a fixing member for fixing the supporting member to a predetermined portion of the vertical body.
